(19) United States
(12) Patent Application Publication
(10) Pub. No.: US 2025/0338215 A1
(43) Pub. Date: Oct. 30, 2025

(54) SYSTEMS AND METHODS FOR DEFINING POWER SAVE CAPABILITIES IN ULTRA HIGH RELIABILITY (UHR)

(71) Applicant: SAMSUNG ELECTRONICS CO., LTD., Suwon-si (KR)

(72) Inventors: Manasi EKKUNDI, Bangalore (IN); Karthik Srinivasa GOPALAN, Bangalore (IN); Abhishek CHATURVEDI, Bangalore (IN)

(21) Appl. No.: 19/264,768

(22) Filed: Jul. 9, 2025

Related U.S. Application Data
(63) Continuation of application No. PCT/KR2025/005121, filed on Apr. 15, 2025.

(30) Foreign Application Priority Data
Apr. 17, 2024 (IN) 202441030859
Mar. 26, 2025 (IN) 202441030859

(51) Int. Cl. H04W 52/02

(52) U.S. Cl. CPC H04W 52/0229

(57) ABSTRACT

Embodiments disclosed herein relate to systems and methods for defining power save capabilities in Ultra High Reliability (UHR). The methods include defining a frame format of power save capabilities in a new framework. The methods include introducing a capability exchange procedure enabled due to the new framework, its associated frame format and overall procedure. For example, the method includes determining, by a transmitting device, whether to send one or more power stave features to the receiving device. The method also includes, generating, by the transmitting device, at least one information field in at least one frame associated with indicating the one or more power save features. The method also includes transmitting the at least one generated information field in the at least one frame associated with indicating the one or more power save features to the receiving device.

### CROSS REFERENCE TO RELATED APPLICATION

This application is a continuation application of International Application No. PCT/KR2025/005121 designating the United States, filed on Apr. 15, 2025 in the Korean Patent Office and claiming priority to Indian Provisional Application No. 202441030859 filed on Apr. 17, 2024, in the Intellectual Property India Office, and Indian Complete Patent Application No. 202441030859 filed on Mar. 26, 2025, all of which are incorporated by reference herein in their entireties.

### TECHNICAL FIELD

The disclosure relates to wireless communication networks, and more particularly to systems and methods for defining power save capabilities in Ultra High Reliability (UHR).

### BACKGROUND

Wireless local area networks (WLAN) technology has evolved towards increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

To implement extremely low latency and extremely high throughput for some applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA. The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The IEEE 802.11 is often backwards compatible with legacy standards in order to have coexistence between many different versions of legacy STAs and STAs with a latest capability or newer STAs. The IEEE 802.11 family of standards has also introduced many power-saving features. In some cases, it is essential for power saving procedures utilized that both the AP and the non-AP STA support a respective power saving feature in order for the power saving feature to be applied. In some examples, support for the power save feature is exchanged via a Capability Information field between the AP and the non-AP STA. In at least some examples, the Capability Information field is exchanged via a Beacon, Probe Response, Association Request/Response frames, Reassociation request/response frames, etc.

With the introduction of MLO, an examination of new power saving capabilities for multi-link operations and the signaling needed to indicate support for the same is ongoing. In one example, the 802.11 Task Group (TGbe) introduced power save features such as a Dynamic Power Save (DPS), a scheduled Power Save (PS), a cross-link PS, and so on. The dynamic power save feature is defined for an STA that is an Ultra High Reliability (UHR) device e.g., a UHR mobile AP or a UHR non-AP STA. In some examples, the STA may transition from a lower capability mode to a higher capability mode upon reception of an initial control frame. In some examples the lower capability mode includes a 20 MHz Bandwidth (BW), one Spatial Stream (SS), and limited data rates, and the lower capability mode has a Physical layer Protocol Data Unit (PPDU) format. In some examples, the higher capability mode includes an operating BW, a Number of Spatial Stream (NSS) and a Modulation and Coding Schemes (MCSs), where at least one capability of the higher capability mode is higher than a respective capability in the lower power capability mode. In some examples, the scheduled PS feature is defined to optionally indicate or update a periodic unavailability in time to its peer STA. In at least one example, the cross link PS allows a non-AP MLD to indicate to an associated AP MLD the power management mode for one or more of its affiliated non-AP STAs—e.g., when the AP MLD supports the mechanism, the power management mode is sent in a frame over an enabled link,

Each of the power save features are associated with capabilities that need to be exchanged between the AP and non-AP STA to indicate support and related parameters associated with the capability. However, currently there is no common framework for exchanging the capability information of each power save feature. That is, each updated version (e.g., newest version) of the IEEE 802.11 family of standards introduced a new power save feature that is distributed across various sub-fields, but without regard to whether the receiving device is capable of such power save features. Such a design may hamper the extensibility of the framework. For example, a typical AP usually implements multiple power save features to support the legacy devices. The current design of capability framework exchange does not support an extensible framework to include multiple power save features.

Different implementations of MLDs can exist from different vendors where cross-link information exchange delay could vary based on an implementation. Further, depending on the implementation, different links of an MLD could support different power save features. But the current framework does not provide a mechanism to detail the capability of power save features for each link to consider implementation aspects. There is hence a need to introduce more details in capabilities and provide the flexibility to the vendor on the type of power save features that can be implemented and the corresponding capability exchanged.

### SUMMARY

One aspect of the present disclosure provides systems and methods for defining one or more power save capabilities in Ultra High Reliability (UHR) and future specifications.

One aspect of the present disclosure provides a common framework to adapt to different types of existing and future power save capabilities.

One aspect of the present disclosure provides systems and methods for defining a frame format of power save capabilities in the new framework.

One aspect of the present disclosure provides systems and methods for introducing a capability exchange procedure enabled due to the new framework, its associated frame format and overall procedure.

One aspect of the present disclosure provides systems and methods for defining a frame format for dynamic power save capabilities in single and multi-link operations.

One aspect of the present disclosure provides systems and methods for defining a frame format for scheduled power save capabilities in single and multi-link operations.

One aspect of the present disclosure provides systems and methods for defining a frame format for cross-link power save capabilities.

One aspect of the present disclosure provides a device which comprises at least one processor including processing circuitry and memory storing instructions. The instructions, when executed by the at least one processor individually or collectively, cause the device to generate at least one frame to include at least one information field. The at least one information field indicates one or more power save features. The instructions, when executed by the at least one processor individually or collectively, further cause the device to transmit the at least one frame including at least one generated information field to the receiving device. In some examples, the device comprises at least one Access Point (AP), and the receiving device comprises at least one non-AP Station (non-AP STA). In some examples, the device comprises the at least one non-AP STA and the receiving device comprises the at least one AP.

One aspect of the present disclosure provides a first device including at least one processor including processing circuitry and memory storing instructions. The instructions, when executed by the at least one processor individually or collectively, cause the first device to transmit, to a second device, a request for one or more power save features that is supported at the second device. The instructions, when executed by the at least one processor individually or collectively, further cause the first device to receive, from the second device, at least one frame including at least one information field. The at least one information field indicates the one or more power save features. The instructions, when executed by the at least one processor individually or collectively, further cause the first device to determine the one or more power save features that is supported in the second device based on the at least one information field in the at least one frame. In some examples, the device comprises at least one Access Point (AP), and the receiving device comprises at least one non-AP Station (non-AP STA). In some examples, the device comprises the at least one non-AP STA and the receiving device comprises the at least one AP.

One aspect of the present disclosure provides a method for facilitating communication in a wireless communication network by at least one transmitting device. The method includes generating, by a transmitting device, at least one frame including at least one information field. The at least one information field indicates the one or more power save features. The method includes transmitting, by the transmitting device, the at least one frame including the at least one information field to the receiving device.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustrator drawings. Embodiments herein are illustrated by way of examples in the accompanying drawings, and in which:

FIG. 1A depicts an example of a capability information field to include an Automatic Power Save Delivery (APSD) feature capability, according to existing arts;

FIG. 1B depicts an example that shows capability for Power Save Multi-Poll (PSMP) in an extended capabilities field, according to existing arts;

FIG. 1C depicts an example of High Throughput (HT) capabilities for the power save feature called Spatial Multiplexing-Power Save (SMPS), according to existing arts;

FIG. 1D depicts an example of Very High Throughput (VHT) capabilities for the power save feature called Transmit Opportunity (TXOP) Power save, according to existing arts;

FIG. 1E depicts an example of High Efficiency (HE) capabilities that includes HE-Dynamic Power Save capability within HE capabilities, according to existing arts;

FIG. 1F depicts an example of an Extremely High Throughput (EHT) capabilities that exchanges the Restricted Target Wake Time (R-TWT) support within EHT capabilities, according to related arts;

FIG. 2 depicts a block diagram of a system for communicating one or more power save capabilities in a wireless communication network, according to embodiments as disclosed herein;

FIG. 3 depicts a method for communicating power save capabilities by a transmitting device in a wireless communication network, according to embodiments as disclosed herein;

FIGS. 4A and 4B depict a block diagram introducing power save capabilities within a UHR capability information field, and candidate power save feature capabilities support within a UHR MAC capabilities field, according to embodiments as disclosed herein;

FIG. 5 depicts an example power save capabilities information field, according to embodiments as disclosed herein;

FIG. 6 depicts an example frame format for the power save capabilities, according to embodiments as disclosed herein;

FIG. 7A depicts a process of power save capability exchange, according to embodiments as disclosed herein;

FIG. 7B depicts a frame body for a capability request message, according to embodiments as disclosed herein;

FIG. 8 depicts a frame format of dynamic power save feature capabilities for a single link operation, according to embodiments as disclosed herein;

FIG. 9 depicts dynamic power save feature capabilities for multi-link operations, according to embodiments as disclosed herein;

FIG. 10 depicts scheduled power save feature capabilities for single link operations, according to embodiments as disclosed herein;

FIG. 11 depicts scheduled power save feature capabilities for multi-link operations, according to embodiments as disclosed herein; and

FIG. 12 depicts power save feature capabilities required to exchange for cross-link power save feature, according to embodiments as disclosed herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

In one embodiment, the following Table 1 depicts different power save features in different capabilities—e.g., different power saving features introduced across different standards.

TABLE 1

| Feature | Capabilities Mapping |
|---|---|
| Automatic Power Save Delivery (APSD) | Capability Information field |
| Power Save Multi-Poll (PSMP) | Extended Capabilities field |
| Wireless Network Management (WNM) Sleep Mode | Extended Capabilities field |
| Flexible Multicast Service (FMS) | Extended Capabilities field |
| Traffic Indication Map (TIM) Broadcast | Extended Capabilities field |
| Spatial Multiplexing-Power Save (SMPS) | High Throughput (HT) capabilities |
| Transmit Opportunity (TXOP) Power Save | Very High Throughput (VHT) capabilities |
| High Efficiency (HE)-Dynamic Power Save | High Efficiency (HE) Capabilities |
| Restricted Target Wake Time (TWT) support | Extremely High Throughput (EHT) |
| | capabilities |

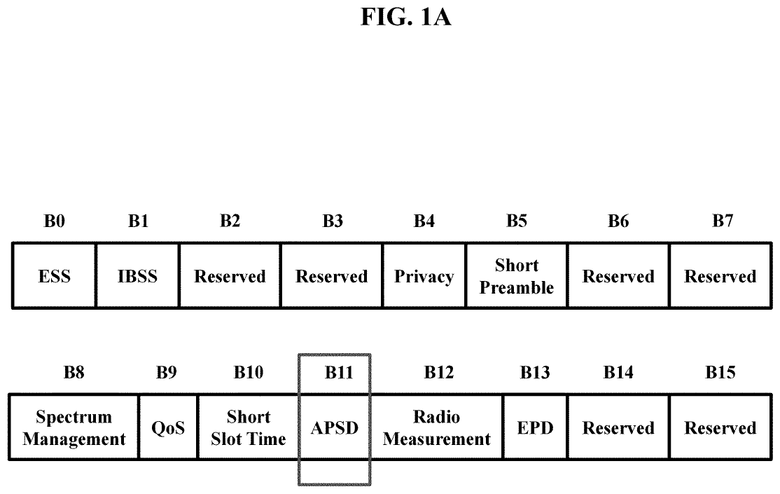

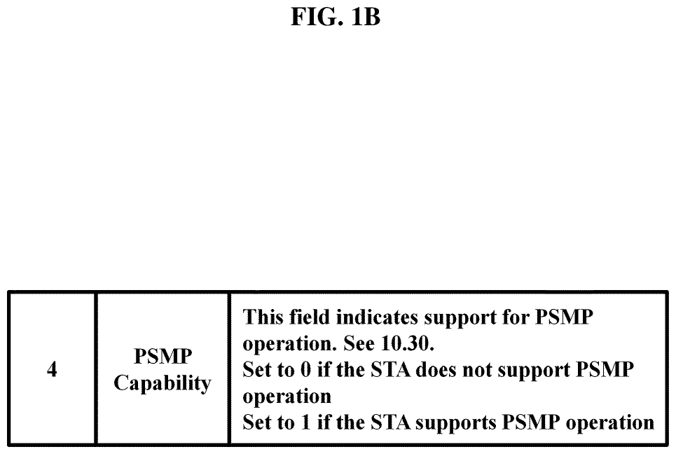

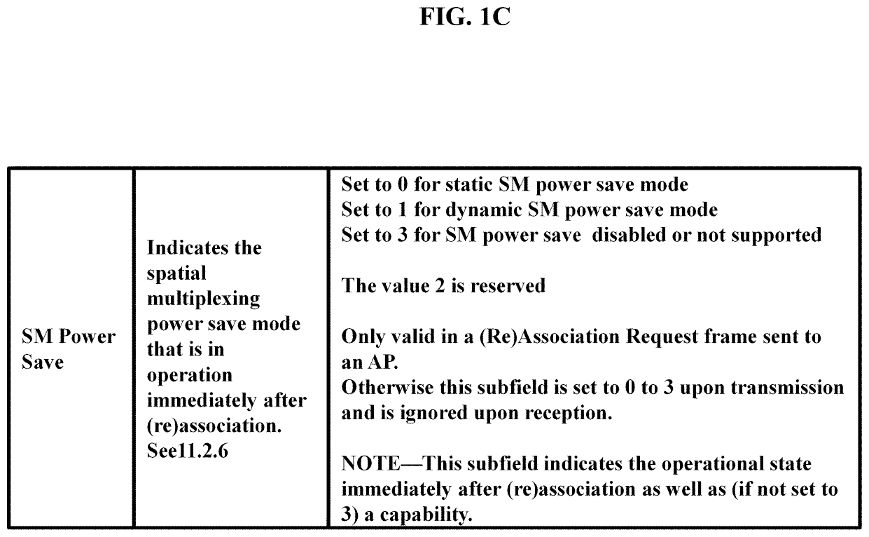

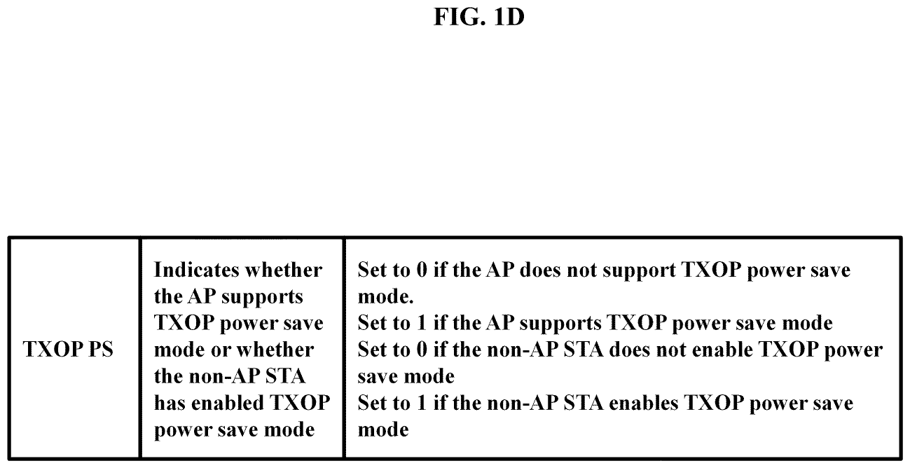

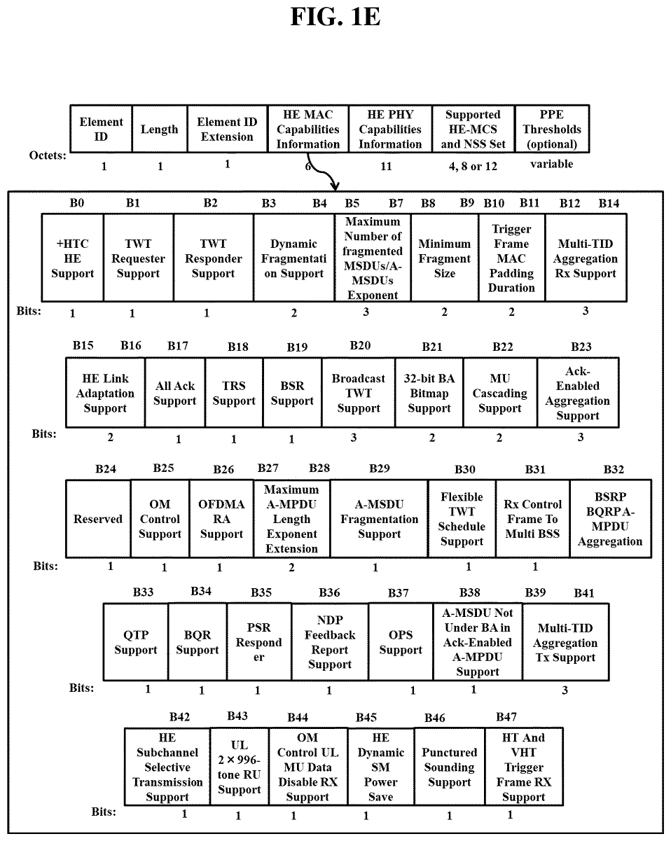

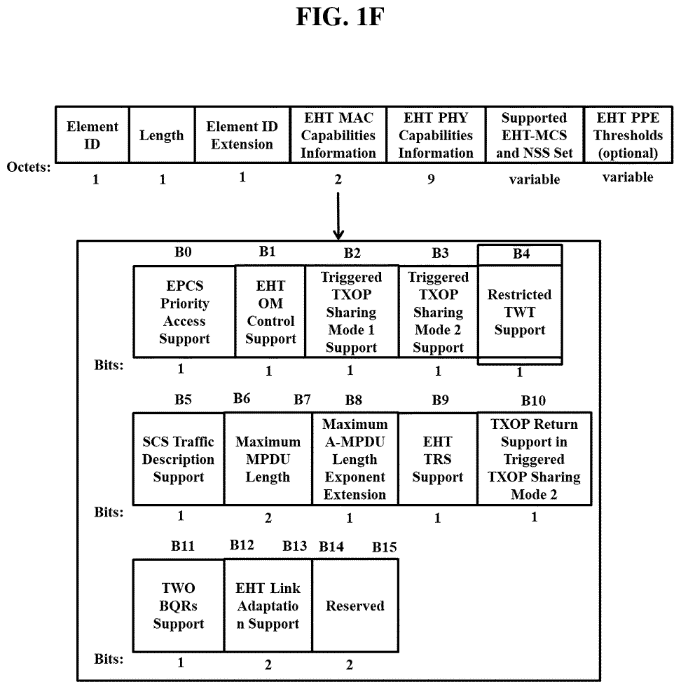

FIG. 1A to FIG. 1F are representations of existing arts illustrating the different power save features of Table 1 and a field one or more of the power save features are transmitted in or indicated at.

For example, FIG. 1A depicts an example of a capability information field to include an APSD feature capability. In one embodiment, a bit (e.g., bit eleven (B11)) of the capability information includes a power save feature—e.g., includes the APSD feature. Accordingly, the ASPD feature can be utilized based on a value of the field in the capability information.

FIG. 1B depicts an example that shows capability for Power Save Multi-Poll (PSMP) in an extended capabilities field. In one embodiment, a field (e.g., field four (4)) of the extended capabilities field includes a power save feature—e.g., includes the power save multi-poll (PSMP) feature. Accordingly, the PSMP feature can be utilized based on a value of the field in the extended capabilities field. For example, if the STA does not support PSMP operations, the field can have a value zero ‘0’. In other examples, if the STA does support PSMP operations, the field can have a value one ‘1.’

FIG. 1C depicts an example of High Throughput (HT) capabilities for the power save feature called Spatial Multiplexing-Power Save (SMPS). In one embodiment, a field (e.g., SM power save field) of the HT capabilities includes a power save feature—e.g., includes the SMPS feature. In some examples, the SMPS field can indicate the SMPS that is in operation after a reassociation operation. In at least one embodiment, the SMPS feature can be utilized based on value of the field in the HT capabilities. For example, the field is set to zero ‘0’ for a static SMPS mode, the field is set to ‘one’ for a dynamic SMPS, and the field is set to three ‘3’ to indicate that the SMPS is disabled or not supported. In some examples, a value ‘2’ is reserved for the field. In at least one embodiment, the SMPS is valid if it is in a reassociation request frame sent to an AP e.g., that is the SMPS can be set to a zero ‘0’ or three ‘3’ if it is not a reassociation request and the SMPS is ignored upon reception.

FIG. 1D depicts an example of Very High Throughput (VHT) capabilities for the power save feature called Transmit Opportunity (TXOP) Power save. In one embodiment, a field of the VHT capabilities (e.g., TXOP PS) includes a power save feature—e.g., includes the TXOP power save. Accordingly, the TXOP PS feature can be utilized based on a value of the TXOP PS field in the VHT capabilities. For example, if the AP does not support TXOP PS mode, the field can be set to a value zero ‘0.’ In other examples, if the non-AP STA does not enable TXOP PS mode, the field can also be set to the value zero ‘0.’ In at least one embodiment, if the AP supports the TXOP PS mode, the field can be set to a value ‘1.’ In other embodiments, if the non-AP STA enables the TXOP PS mode, the field can also be set to the value one ‘1.’

FIG. 1E depicts an example of High Efficiency (HE) capabilities that includes HE-Dynamic Power Save capability within HE capabilities. In one embodiment, a field of the HE capabilities includes a power save feature. For example, the sixth octet of the HE capabilities field can include HE medium access control (MAC) capabilities information. In at least one embodiment, a bit (e.g., B45) of the HE MAC capabilities information can include information about the HE dynamic power save. Accordingly, the HE-Dynamic Power Save feature can be utilized based on a value of the bit (e.g., B45) in the HE capabilities information.

FIG. 1F depicts an example of Extremely High Throughput (EHT) capabilities that exchanges the Restricted Target Wake Time (R-TWT) support within EHT capabilities. In one embodiment, a field of the EHT capabilities includes a power save feature. For example, a second octet of the EHT capabilities field can include EHT MAC capabilities information. In at least one embodiment, a bit (e.g., B4) of the EHT MAC capabilities information can include information about the restricted TWT support. Accordingly, the R-TWT support feature can be utilized based on the value of the bit (e.g., B4) in the EHT capabilities information.

In at least one embodiment, there is no common framework to transmit and receive the above mentioned power save features.

Embodiments described herein, though, achieve systems and methods for defining power save capabilities in Ultra High Reliability (UHR).

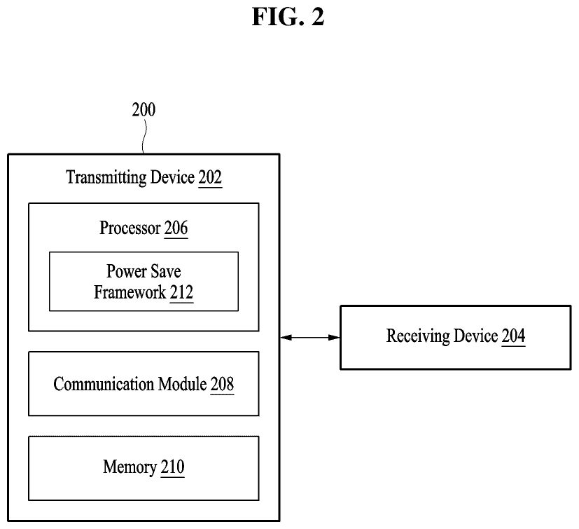

FIG. 2 depicts a block diagram of a system 200 for communicating one or more power save capabilities in a wireless communication network. The system 200 comprises at least one transmitting device 202 and at least one receiving device 204. In an embodiment herein, the transmitting device 202 and the receiving device 204 can be an example of a device capable of using Wi-Fi technology—e.g., the transmitting device 202 and receiving device 204 can be an example of any device capable of using a WIFI network or technology. In an embodiment herein, the transmitting device 202 can be at least one of an Access Point (AP) or a non-AP Station (non-AP STA). In an embodiment herein, the receiving device 204 can be at least one of the non-AP STA or the AP. In one embodiment, the transmitting device 202 and the receiving device 204 are different devices—e.g., the transmitting device 202 is an AP and the receiving device 204 is a non-AP STA or vice versa. The transmitting device 202 can comprise a processor 206, a communication module 208, and a memory 210. Although not illustrated, in an embodiment herein, the receiving device 204 can also be understood by those familiar with the art to include a processor, a communication module, a memory, and a power save framework, where the receiving device 204 can be able to receive a frame, and decode and process the frame to understand the power save capabilities of the transmitting device 202. For example, the receiving device 204 can include a processor with a power save framework capable of receiving the frames from communication module 208, decode the frames, and process the frames to understand the power save capabilities of the transmitting device 206.

In an embodiment herein, the processor 206 can define a new power save capabilities framework exchange for one or more power save features in UHR, and future versions of the specification—e.g., the power save capability framework exchange described herein can be utilized for a current UHR standard as well as for future standards. The processor 206 can provide a frame format definition of the power save capabilities in the defined power save capabilities framework. The processor 206 can enable a capability exchange procedure, and its associated frame format and overall procedure. In an embodiment herein, the processor 206 can provide a frame format definition for dynamic power save capabilities in single and multi-link operations (MLO). In some examples, the processor 206 can provide a frame format definition for scheduled power save capabilities in single and multi-link operations. In at least one embodiment, the processor 206 can provide a frame format definition for cross-link power save capabilities. In one embodiment, the processor 206 can further comprise a power save framework 212.

In an embodiment, the power save framework 212 can determine whether to send one or more power save features to at least one receiving device 204. For example, the power save framework 212 can determine whether one or more power save features are implemented in the transmitting device 202. In at least one embodiment, the power save framework 212 can determine a power save feature implemented in transmitting device 202 and send the respective power save feature to the receiving device 204.

In an embodiment, the power save framework 212 can generate at least one information field in at least one frame for the determined power save features. In some examples, the power save framework 212 can further transmit the at least one generated information field to the receiving device 204. In an embodiment, the power save framework 212 can generate the at least one information field related to one or more power save capabilities in one or more frames to support functioning of the power save features in one or more frames. That is, the power save framework 212 can generate multiple frames to include multiple power save capabilities in the at least one information field. In an example, the power save capabilities comprises at least one of a dynamic power save feature support, a scheduled power save feature support, a cross-link power save feature support, or an assistance support for peer STA to enable the power save features and associated parameters. In some examples, each frame can include, but is not limited to, a Beacon field, an Association request/response field, a (Re)association request/response field, and a Probe request/response field.

In an embodiment, the power save framework 212 can generate the information field related to the power save capabilities in the frames through at least one UHR capability information field. For example, the power save features and associated power save capabilities are introduced in a UHR Media Access Control (MAC) capabilities field of the UHR capability information field. In such embodiments, the UHR MAC capabilities field can include support for each power save feature.

In one embodiment, the power save framework 212 can generate the information field related to the power save capabilities in the frames through at least one power save capabilities information field. For example, the power save features and associated power save capabilities are introduced directly in the power save capabilities information field. In such embodiments, the power save capabilities information field of the at least one frame can comprise at least one of an associated element identity (ID) or an element ID extension.

In some examples, the power save capabilities information field can include, but is not limited to, a support of a type of a power save feature, a frame format for each power save capability associated with the power save feature, at least one mode of the power save feature, a number of links supported, and a link ID for each supported link. In at least one embodiment, the type of the power save feature can include, but is not limited to a dynamic power save feature, a scheduled power save feature, or a cross-link power save feature. In an embodiment, each power save feature is enabled if a corresponding dot11 feature support is implemented for indicating a supporting value for implementing the power save feature.

In an embodiment, the dynamic power save feature can operate in at least one of a low capability mode or a high capability mode. In some examples, the dynamic power save feature supports at least one of a single-link operation or a multi-link operation.

In some examples, the scheduled power save feature can comprise a doze mode capability for indicating support to at least one of a listen mode or a reduced capability mode. In such examples, the scheduled power save feature can support at least one of a single-link operation or a multi-link operation.

In an embodiment, the frame format can include, but is not limited to, a power save feature ID and/or a length and details per each power save feature.

In some examples, the mode of the power save feature can include, but is not limited to, a Bandwidth (BW), a Number of Spatial Stream (NSS), and/or a Modulation and Coding Scheme (MCS). In an embodiment=, the mode of the power save feature can be applicable for one of a low capability mode or a high capability mode.

In an embodiment herein, the processor 206 includes processing circuit and processes and executes data of a plurality of modules of the transmitting device 202. In at least one embodiment, the processor 206 can be configured to execute instructions stored in the memory 210. The processor 206 may comprise one or more microprocessors, circuits, and other hardware configured for processing. In an embodiment, the processor 206 can be at least one of a single processer, a plurality of processors, multiple homogeneous or heterogeneous cores, multiple Central Processing Units (CPUs) of different kinds, microcontrollers, special media, and other accelerators. The processor 206 may be an example of an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 206 of the transmitting device 202 can communicate via the communication module 208. In some examples, the communication module 208 may be in the form of either a wired network or a wireless communication network module. The wireless communication network may comprise, but is not limited to, a Global Positioning System (GPS), a Global System for Mobile Communications (GSM), Wi-Fi, Bluetooth low energy, Near-field communication (NFC), etc. In some examples, the wireless communication may further comprise one or more of Bluetooth, ZigBee, a short-range wireless communication (such as Ultra-Wideband (UWB)), a medium-range wireless communication (such as Wi-Fi), or a long-range wireless communication (such as 3G/4G/5G/6G and non-3GPP technologies or WiMAX), according to the usage environment.

In an embodiment herein, the memory 210 may comprise one or more volatile and non-volatile memory components which are capable of storing data and instructions of the modules of the transmitting device 202 to be executed. Examples of the memory 210 can be, but are not limited to, NAND, embedded Multi Media Card (eMMC), Secure Digital (SD) cards, Universal Serial Bus (USB), Serial Advanced Technology Attachment (SATA), solid-state drive (SSD), etc. The memory 210 may also include one or more computer-readable storage media. In some examples, the memory 210 can be examples of non-volatile storage elements, such as magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted to mean that the memory 210 is non-movable. In certain examples, a non-transitory storage medium may store data that can, over time, change (for example, in Random Access Memory (RAM) or cache).

FIG. 2 shows example modules of the transmitting device 202, but it is to be understood that some embodiments are not limited thereon. In some embodiments, the transmitting device 202 may include less or more number of modules. Further, the labels or names of the modules are used only for illustrative purpose and do not limit the scope of the invention. One or more modules can be combined together to perform same or substantially similar function in the transmitting device 202.

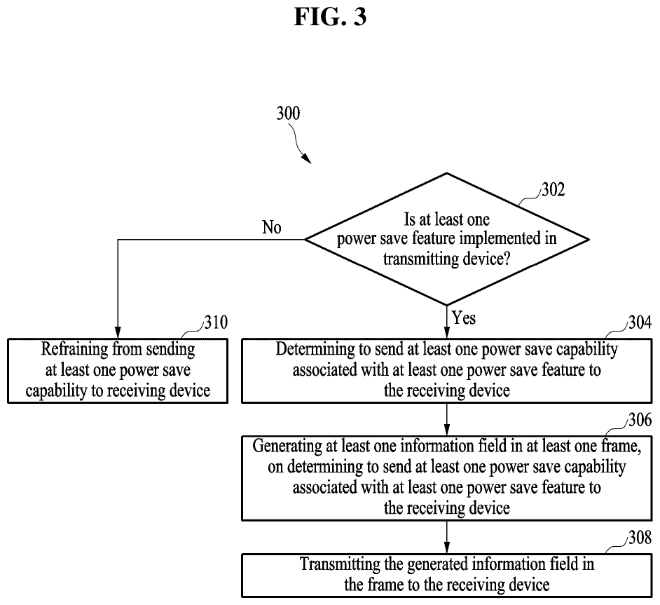

FIG. 3 depicts a method 300 for communicating power save capabilities by a device or the transmitting device 202 in a wireless communication network. The various actions in method 300 may be performed in the order presented, in a different order or simultaneously. Further, in some examples, some actions listed in FIG. 3 may be omitted. In some examples, the operations, actions, or steps described herein are performed by a transmitting device (e.g., transmitting device 202) and a receiving device (e.g., receiving device 204) as described with reference to FIG. 2. In at least one embodiment, portions of the actions and operations described herein are performed by the power save framework 212.

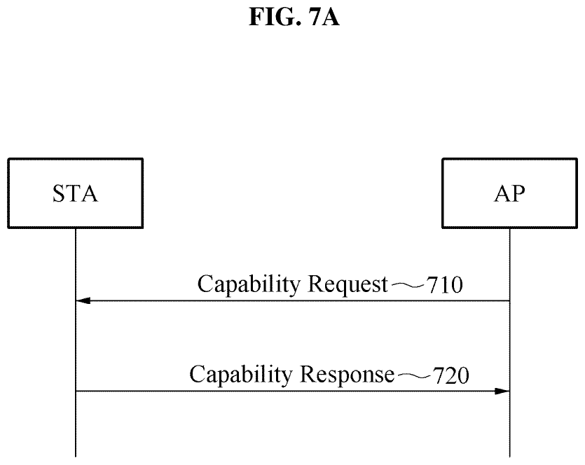

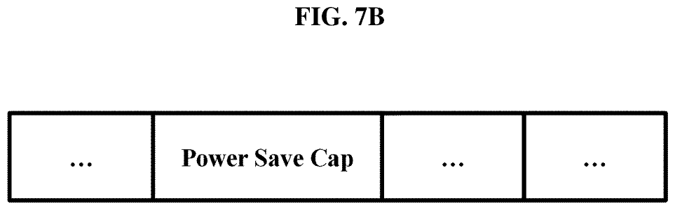

At step 302, the method 300 includes determining whether one or more power save features are implemented in the transmitting device 202. In at least one embodiment, the power save framework 212 determines there are no power save features implemented in the transmitting device 202. In such embodiments, at step 310, the power save framework 212 can refrain from sending at least one power save capability to the receiving device 204—e.g., the power save framework 212 does not transmit a power save capability when the transmitting device 202 is not associated with a power save feature. In some examples, the transmitting device 202 determines at least one power save feature implemented in the transmitting device 202. In such embodiments, the method proceeds to step 304. In at least some examples, the transmitting device 202 can send or receive a capability request before step 302 as described with reference to FIG. 7A.

At step 304, the method 300 includes determining to send at least one power save capability associated with at least one power save feature to the receiving device 204.

At step 306, the method 300 includes generating at least one information field in at least one frame based on determining to send at least one power save capability associated with at least one power save feature to the receiving device 204 at step 304. In at least one embodiment, the transmitting device 202 can generate the at least one information field in the at least one frame of a capability response message as described with reference to FIG. 7A.

At step 308, the method 300 includes transmitting the generated information field in the frame to the receiving device 204.

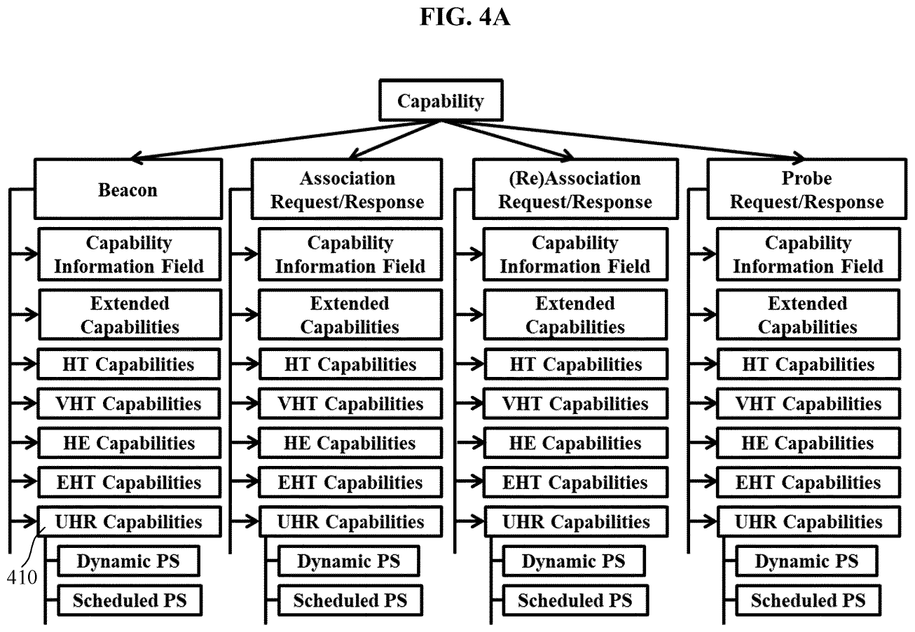

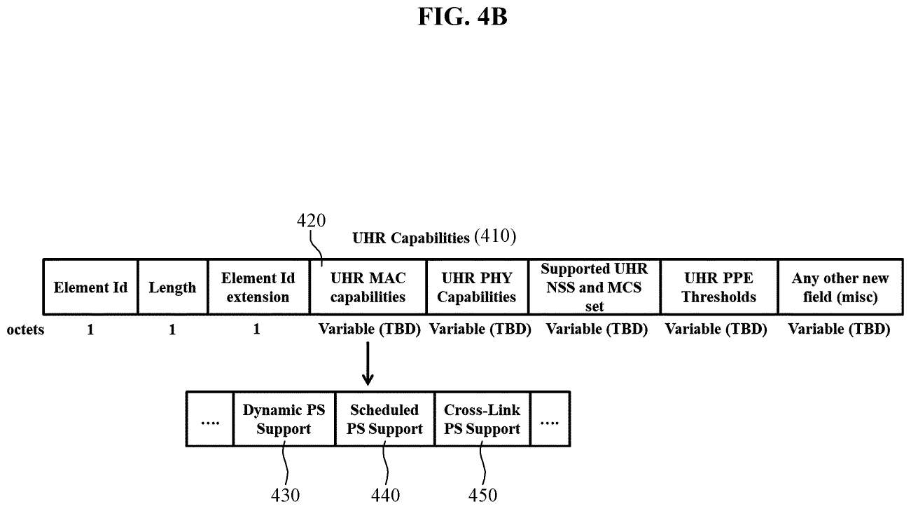

In some examples, the method 300 extends the power save capabilities within the UHR capability information field 410 and introduces the candidate power save feature capabilities support within the UHR MAC capabilities field 420, as depicted in FIG. 4A and FIG. 4B. In some examples, The UHR MAC capabilities field 420 of the UHR capabilities information field 410 includes fields for the candidate power save features, for example, the dynamic power save feature field 430, the scheduled power save feature field 440, and the cross-link power save field 450. These fields are further extended in subsequent examples.

In one embodiment, the transmitting device 202 can send the capability in multiple packets. That is, scalability and extensibility issue exist as each version of 802.11 may end up introducing its own Information Element (IE) field, and each IE field is transmitted in a different respective packet. For example, FIG. 4A depicts an example scenario, wherein the capability is being sent in multiple packets. In one embodiment, the capability information can include a beacon, an association request/response, a (re)association request/response, and/or a probe request/response. In some examples, each respective message or response can include one or more packets. For example, the beacon message can include a capability information field, an extended capabilities field, an HT capabilities field, etc. In such embodiments, each respective field can include additional information. For example, the UHR capabilities can include a dynamic PS, a scheduled PS, a cross-link PS support, etc. In one embodiment, the individual power save feature information is illustrated with reference to FIG. 4B.

In one embodiment, FIG. 4B shows illustrates UHR MAC capability fields 420. For example, FIG. 4B illustrates that when the UHR MAC capability fields 420 are introduced, the UHR MAC capabilities shall consider introduction of the power save features like dynamic power save, scheduled power save, and/or cross link power save mechanisms. The proposed method 300 includes the UHR capabilities that contain the power save capabilities as shown in FIG. 4B, within each of capability information field in the Beacon, Association request/response, (re)association request/response, Probe request/response messages, etc.

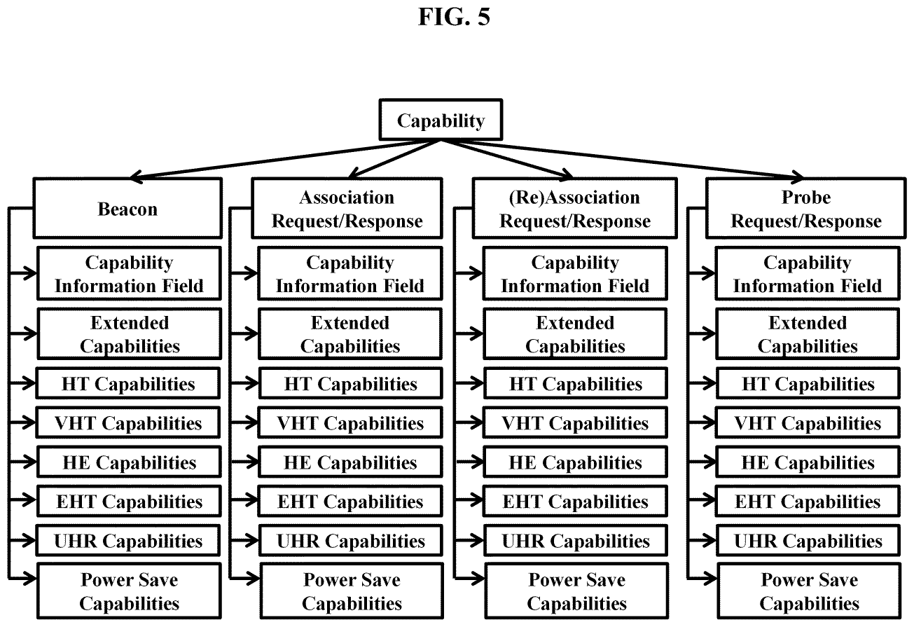

Embodiments as shown in FIGS. 5, 6, 7A, and 7B herein can separately indicate the power save capabilities in the Beacon, Association request/response, (re)association request/response, Probe request/response messages, etc. The method 300 is forward compatible to future releases of Wi-Fi, enabling the method to be more modular and extensible.

In at least one embodiment, implementing method 300 includes adding the following elements, syntax, definitions in the specification or standard (e.g., for WIFI 8): introduces power save feature capabilities in Beacon, (Re)association request/response, Probe request/response frames, addition of associated elements and their respective element ID details, define a frame format for power save capabilities, introduction of a power save name or identity (e.g., that is, each power save feature can have a format—e.g., dot11_<name>_powersavefeatureimplemented, where a dynamic power save is dot11dynamicpowersavefeatureimplemented, scheduled power save is dot11scheduledpowersavefeatureimplemented, and crosslink power save is dot11crosslinkpowersavefeatureimplemented), and a capability exchange framework for sending power save capabilities. In at least one embodiment, for the introduction of the power save name (e.g., for the introduction of dot11_<name>_powersavefeatureimplemented), when the feature is implemented, a corresponding value is set to true—e.g., when the dynamic power save feature is implemented the value of dot11dynamicpowersavefeatureimplemented is set to “TRUE.” In at least one embodiment, the power save feature is used in the capabilities information element to populate an associated information element. In some examples, the dot11 feature is a corresponding second feature support implemented for indicating a support value for implemented the power save feature—e.g. indicating the “TRUE” value.

FIG. 5 depicts an example power save capabilities information field. As shown below in FIG. 5, the 802.11bn specification can introduce power save capabilities information field separately, and the power save capabilities information field can be included within Beacon, (re)association request/response, probe request/response fields. That is, as described with reference to method 300, instead of having power save features within the UHR capabilities, the power save features are transmitted in a separate new field—e.g., in the power save capabilities field. FIG. 5 illustrates this new field (e.g., power save capabilities) for each of the beacon, association request/response, (re)association request/response, and the probe request/response.

FIG. 5 describes a frame body format to contain power save feature capabilities. In one embodiment, the frame body is depicted in Table 2, as defined for each of the Beacon, (Re)association request/response, Probe request/response, where the frame body contains the newly defined power save capabilities.

TABLE 2

| Order | Information | Notes |
|---|---|---|
| Last order-1 | Power Save | The power save feature capabilities |
| | Capabilities | element is present when |
| | | dot11PowerSaveFeaturesOptionImplemented |
| | | is true. |

In at least one embodiment, a new power save capabilities information element that introduces an associated element identification (ID)/Element ID extension is defined, as described with reference to method 300. In some examples, though, an exact number of the ID may depend on the specification. That is, the element ID and the element ID extension may vary depending on a standard or specification utilized. For example, when power save capabilities IE is introduced, the power save capabilities IE will have a format as illustrated in an entry in the Element ID as shown below table. Table 3 depicts an element ID for power save feature capabilities.

TABLE 3

| | | Element ID | | Frag- |
|---|---|---|---|---|
| Element | Element ID | extension | Extensible | mentable |
| Power Save | XX (it will | YY (it will | Yes | TBD |
| Feature | depend on the | depend on the | | |
| capabilities | specification | specification | | |
| | number) | number) | | |

As described above and herein, though, Table 3 is one example of a format the element ID/element ID extension can have. Other formats are possible.

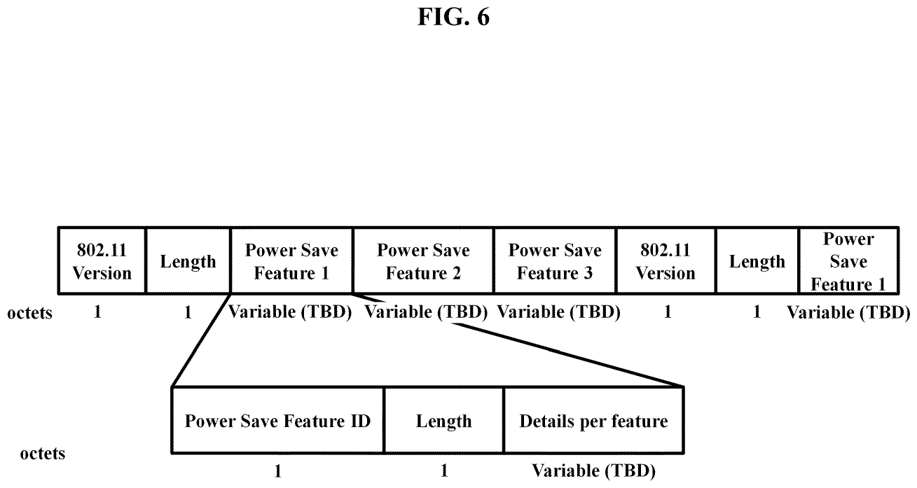

FIG. 6 depicts an example frame format for the power save capabilities. In one embodiment, FIG. 6 illustrates the power save capabilities frame can have a format that includes a first octet associated with an 802.11 version—e.g., which version of 802.11 is the feature used in. In some examples, the power save capabilities frame can also include a length—e.g., the length field is an indicator of the length of the capabilities in the current version of the 802.11 specification. In some examples, the power save capabilities frame can also include the one or more power save features. For example, the frame can include a power save feature 1, a power save feature 2, and a power save feature 3. In at least one embodiment, a length of the power save feature is variable—e.g., power save feature 1 and power save feature 2 can have different lengths. In at least one embodiment, Table 4 illustrates the format of a respective power save feature. For example, Table 4 could be an example of the frame of the power save feature 1.

TABLE 4

| Sub-field | Definition | Encoding |
|---|---|---|
| 802.11 Version | This will define the version | 0- tgbn |
| | of 802.11 in which the | 1 - tgbx* |
| | power save feature is | Extensible to future |
| | defined | generations |
| Length | This indicates the length | |
| | of the power save feature | |
| | capability information | |
| Power Save | This defines the power save | Each power save feature |
| Feature n | feature that is part of this | has its own frame format |
| | version of specification | dependent on need. |
| | | Example: |
| | | 1 - Dynamic Power Save |
| | | 2 - Scheduled Power Save |
| | | 3 - Cross link power save |

In some examples, the power save feature 1 is associated with the dynamic power save, the power save feature 2 is associated with the scheduled power, and the power save feature 3 is associated with the cross-link power save.

In some examples, the 802.11 version field of Table 4 is introduced to help maintaining forward and backward compatibility. For example, all the future generations including 802.11bn can use this field to indicate the corresponding power save features. In at least one embodiment, the details per feature field of a respective power save feature field can include information associated with the respective power save feature. For example, the power save feature 1 can include details about the dynamic power save feature.

FIG. 7A depicts a process of a power save capability exchange. In one embodiment, FIG. 7A shows a case where the power save capability can be exchanged without sending it in a Beacon, Probe, Association messages, and/or (re)association messages. In such embodiments, there is flexibility in exchanging features that an AP or STA has an update for. In at least one embodiment, a new message called a capability request message, and its associated capability response message is introduced to transmit and receive the power save capabilities. In some examples, at step 710, the capability request can be transmitted to request power save capabilities. In some examples, at step 720, the capability response message can be transmitted as a response to the capability request and include the power save capability information—e.g., indicate which power save features are implemented by the responding device. In some examples, the capability request is transmitted from the AP to the STA as illustrated in FIG. 7A. In other examples, the capability request is transmitted from the STA to the AP. In such examples, the AP can transmit the capability response to the STA.

For example, at step 1, the AP can send a capability request to request a capability for a particular power save feature(s). In some examples, the AP can request a capability for a dynamic power save feature, a scheduled power save feature, and/or a cross-link power save feature.

At step 2, the STA can respond with a capability response including an associated capability for the power save features that were requested in step 1. For example, the STA can transmit a capability response including information about the dynamic power save feature if the AP transmits the capability request requesting information about the dynamic power save feature.

With the new framework, the AP or STA can request capability using the capability request message. In one embodiment, the capability request message can have a frame format as depicted in the FIG. 7B and expounded on in Table 5. For example, FIG. 7B depicts the frame body for the capability request message being between other not illustrated frames. In at least one embodiment, the power save capability frame shown in FIG. 7B has a format as indicated in Table 5.

TABLE 5

| Sub-field | Definition | Encoding |
|---|---|---|
| Power | This is a bit map that defines | 1 - Power save feature |
| Save Cap | whether the capability | request |
| | requests power save features | 0 - Power save feature |
| | or not | not requested |
| | | Extensible to future |
| | | generations |

That is, the AP or STA can transmit the power save capability frame having a bit map that indicates whether the power save feature is being requested or not e.g., the power save feature is being requested if the bit map has a value one ‘1’ and the power save feature is not being requested if the bit map has a value zero ‘0.’

In some examples, the capability response message is transmitted having a format as depicted in FIG. 6 and expounded on Table 4. That is, the STA can response to the capability request message with the capability response message having the format illustrated in FIG. 6.

In at least one embodiment, detailed power save feature capabilities for each candidate feature is described. For example, detailed power save feature capabilities are described for single link dynamic power saves, multi-link dynamic power saves, single link scheduled power saves, multi-link scheduled power saves, and cross link power saves.

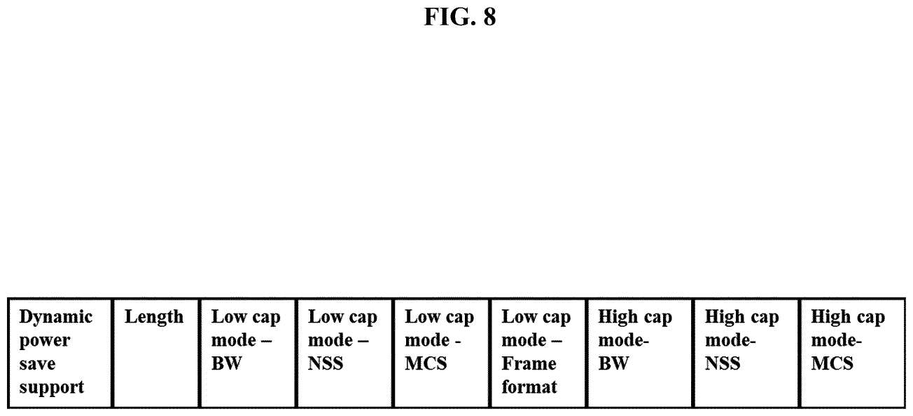

For example, FIG. 8 and Table 6 depict the dynamic power save feature capabilities for a single link operation. FIG. 8 depicts the frame format that can be used in dynamic power save feature capabilities for a single link operation. For example, the dynamic power save feature for a single link operation can include a dynamic power save support field, a length, a low cap mode bandwidth (BW) field, low cap mode number of spatial streams (NSS) field, low cap mode modulation and coding scheme (MCS) field, low cap mode frame format field, high cap mode BW field, high cap mode NSS field, and high cap mode MCS field. In at least one embodiment, Table 6 defines each respective field (e.g., sub-field) as follows.

TABLE 6

| Sub-field | Definition | Encoding |
|---|---|---|
| Dynamic | This indicates whether the | This feature will be supported if |
| power save | dynamic power save feature | dot11dynamicpowersavefeatureimplemented |
| feature | is supported. | is set to TRUE. |
| support | | 1 - Supported |
| | | 0- Indicates not supported |
| Length | This indicates the length of | This field is present if the feature is supported |
| | the power save feature | and otherwise absent. |
| | capability information | |
| Low cap | This defines the maximum | This can be encoded as a 3 bit information |
| mode - BW | bandwidth the device can | 000 - Indicates change in bandwidth is not |
| | support in low capability | supported. |
| | mode | 100- BW change is supported. Only 20 mhz |
| | | 101 - BW change is supported. Up to 40 mhz |
| | | 110 - BW change is supported. Up to 80 mhz |
| | | 111 - BW change is supported. Up to 160 mhz |
| Low cap | This defines the maximum | This can be encoded as a 2 bit information |
| mode - NSS | Spatial streams the device | 00- Indicates changing NSS is not supported |
| | can support in low capability | in low cap mode |
| | mode | 10- Indicates changing NSS is supported. |
| | | Upto 1 NSS |
| | | 11 - Indicates changing NSS is supported |
| | | upto 2 NSS |
| Low cap | This defines the maximum | It can be indicated using 5 bits |
| mode - MCS | MCS that can be supported in | 00000 - Changing MCS in low cap mode is |
| | low capability mode | not supported |
| | | 10000 - Changing MCS is supported. Upto |
| | | BPSK |
| | | . . . |
| | | 11111 - Changing MCS is supported. Upto |
| | | MCS 15 |
| Low cap | This defines which format is | The encoding can include a set of values for |
| mode - | going to be used for the ICF | different formats. |
| Frame format | in low cap mode. | 0 - non-HT(dup) format |
| High cap | This defines the maximum | This can be encoded as a 3 bit information |
| mode - BW | bandwidth the device can | 000 - Indicates change in bandwidth is not |
| | support in high capability | supported. |
| | mode | 100- BW change is supported. Only 40 mhz |
| | | 101 - BW change is supported. Upto 80 mhz |
| | | 110 - BW change is supported. Upto 160 mhz |
| | | 111 - BW change is supported. Upto 320 mhz |
| High cap | This defines the maximum | This can be encoded as a 2 bit information |
| mode - NSS | Spatial streams the device | 00- Indicates changing NSS is not supported |
| | can support in high capability | in low cap mode |
| | mode | 10- Indicates changing NSS is supported. |
| | | Upto 2 NSS |
| | | 11 - Indicates changing NSS is supported |
| | | upto 4 NSS |
| High cap | This defines the maximum | It can be indicated using 5 bits |
| mode - MCS | MCS that can be supported in | 00000 - Changing MCS in high cap mode is |
| | high capability mode | not supported |
| | | 10000 - Changing MCS is supported. Upto |
| | | BPSK |
| | | . . . |
| | | 11111 - Changing MCS is supported. Upto |
| | | MCS 15 |

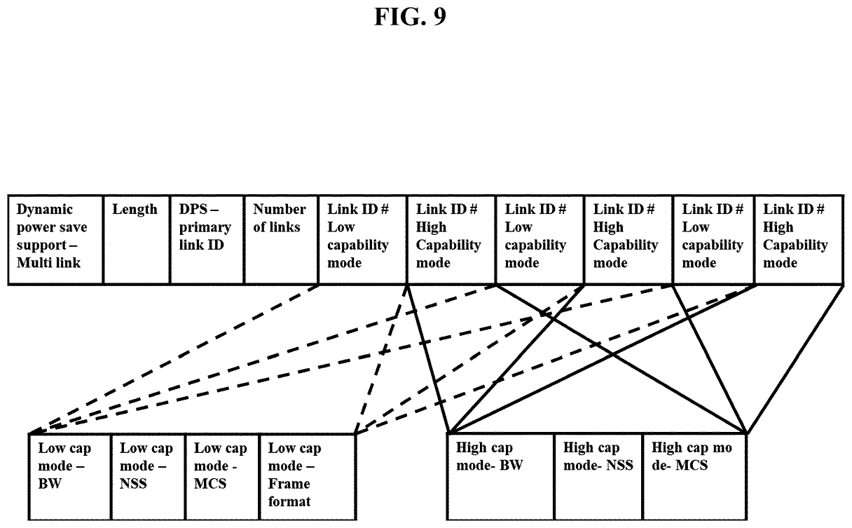

In one embodiment, FIG. 9 and Table 7 depict the dynamic power save feature capabilities for multi-link operations. FIG. 9 depicts the frame format that can be used in dynamic power save feature capabilities for a multi-link operation. For example, the dynamic power save feature for a multi-link operation can include a dynamic power save support multi-link field, a length, a dynamic power save (DPS) primary link identification (ID) field, a number of links field, and one or more link ID #low capability mode and link ID #high capability mode fields. In at least one embodiment, Table 7 defines each respective field (e.g., sub-field) as follows.

TABLE 7

| Sub-field | Definition | Encoding |
|---|---|---|
| Dynamic power | This indicates whether the dynamic | 1 - Supported |
| save support - | power save feature is supported for | 0- Indicates not supported |
| Multi-Link | multi-links | |
| Length | This indicates the length of the | |
| | power save feature capability | |
| | information | |
| DPS-Primary link | This indicates which is the preferred | 1- 2.5 Ghz |
| ID | primary link ID on which the ICF is | 2- 5 Ghz |
| | exchanged during DPS mode | 3- 6 Ghz |
| Number of links | This indicates how many links | |
| | support DPS over multi-link | |
| Link ID # - Low | This defines the link ID and its | The encoding of the |
| capability mode | corresponding low capability mode | features is same as defined |
| | features | for dynamic power save |
| | | for single link. |
| | | It is preceded by Link ID# |
| Link ID # - High | This defines the link ID and its | The encoding of the |
| capability mode | corresponding high capability mode | features is same as for |
| | features | dynamic power save for |
| | | single link. |
| | | It is preceded by Link ID# |

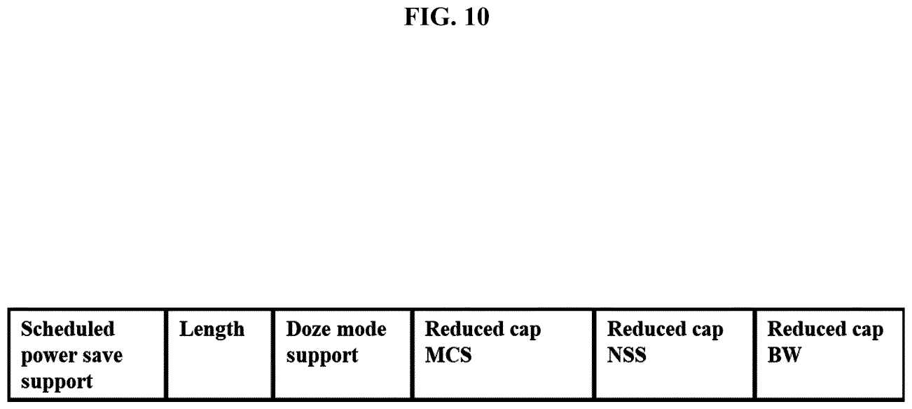

In one embodiment, FIG. 10, and Table 8 depict scheduled power save feature capabilities for single link operations. FIG. 10 depicts the frame format that can be used in scheduled power save features for a single link. For example, the scheduled power save feature for the single link operation can include a scheduled power save support field, a length field, a doze mode support field, a reduced cap MCS field, a reduced cap NSS field, and a reduced cap BW field. In at least one embodiment, Table 8 defines each respective field (e.g., sub-field) as follows.

TABLE 8

| Sub-field | Definition | Encoding |
|---|---|---|
| Scheduled power | This indicates whether | This feature will be supported if |
| save feature | the scheduled power | dot11scheduledpowersavefeatureimplemented |
| support | save feature is | is set to TRUE. |
| | supported. | 1 - Supported |
| | | 0- Indicates not supported |
| Length | This indicates the | This field is present if the feature is supported. |
| | length of the power | Else absent. |
| | save feature capability | |
| | information | |
| Doze mode | This defines the various | 00 - Full Doze mode (no receiving (Rx), no |
| support | doze mode support that | transmitting (Tx)) |
| | the device can support | 01- Listen mode (Rx, no Tx) |
| | | 10 - Listen mode (Rx, Tx) |
| | | 11 - Reduced capability mode |
| Reduced cap | This defines the | This is present if doze mode support filed |
| mode - MCS | maximum MCS that | supports reduced capability mode. |
| | can be supported in | It can be indicated using 5 bits |
| | reduced capability | 00000 - Changing MCS in red cap mode is not |
| | mode. | supported |
| | | 10000 - Changing MCS is supported. Upto |
| | | BPSK |
| | | . . . |
| | | 11111 - Changing MCS is supported. Upto |
| | | MCS 15 |
| Reduced cap | This defines the | This is present if doze mode support filed |
| mode - NSS | maximum Spatial | supports reduced capability mode. |
| | streams the device can | This can be encoded as a 2 bit information |
| | support in Reduced | 00- Indicates changing NSS is not supported in |
| | capability mode | red cap mode |
| | | 10- Indicates changing NSS is supported. Upto |
| | | 1 NSS |
| | | 11 - Indicates changing NSS is supported upto |
| | | 2 NSS |
| Reduced cap | This defines the | This is present if doze mode support filed |
| mode - BW | maximum bandwidth | supports reduced capability mode. |
| | the device can support | This can be encoded as a 3 bit information |
| | in low capability mode | 000 - Indicates change in bandwidth is not |
| | | supported. |
| | | 100- BW change is supported. Only 20 mhz |
| | | 101 - BW change is supported. Upto 40 mhz |
| | | 110 - BW change is supported. Upto 80 mhz |
| | | 111 - BW change is supported. Upto 160 mhz |

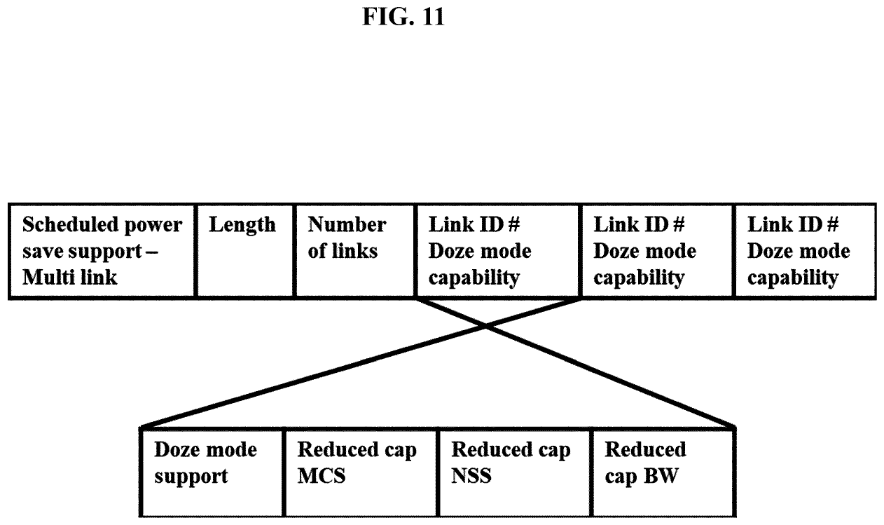

In at least one embodiment, FIG. 11, and Table 9 depict scheduled power save feature capabilities for multi-link operations. FIG. 11 depicts the frame format that can be used in scheduled power save features for multi-link operations. For example, the scheduled power save feature for the multi-link operation can include a scheduled power save support multi-link field, a length field, and one or more link ID #doze mode capability fields, where each link ID #doze mode capability includes a doze mode support field, a reduced cap MCS field, a reduced cap NSS field, and a reduced cap BW field. In at least one embodiment, Table 9 defines each respective field (e.g., sub-field) as follows.

TABLE 9

| Sub-field | Definition | Encoding |
|---|---|---|
| Scheduled power save | This indicates whether the | 1 - Supported |
| feature support - Multi link | scheduled power save feature | 0- Indicates not supported |
| | is supported in multiple links of | |
| | the STA | |
| Length | This indicates the length of the | This field is present if the |
| | power save feature capability | feature is supported. Else |
| | information | absent. |
| Number of links | This indicates how many links | |
| | support SPS over multi-link | |
| Link ID # - Doze mode | This defines the link ID and its | The encoding of the features |
| capability | corresponding doze mode | is same as defined for |
| | capability features | scheduled power save for |
| | | single link operations. |
| | | It is preceded by Link ID#, |
| | | each the identification of |
| | | the link followed by the |
| | | capabilities associated with |
| | | the link |

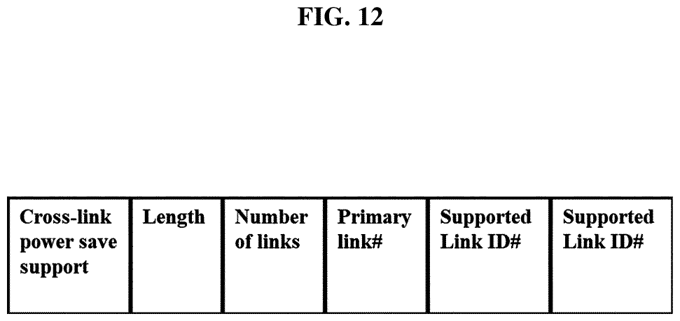

In at least one embodiment, FIG. 12, and Table 10 depict the power save feature capabilities required to exchange for cross-link power save feature. FIG. 12 depicts the frame format that can be used for the cross-link power save feature. For example, the cross-link power save feature frame format can include a cross-link power save support field, a length field, a number of links field, a primary link #field, and one or more supported link ID #fields. In at least one embodiment, Table 10 defines each respective field (e.g., sub-field) as follows.

TABLE 10

| Sub-field | Definition | Encoding |
|---|---|---|
| Cross link | This indicates | This feature will be supported if |
| power save | whether the cross | dot11crosslinkpowersavefeatureimplemented is set |
| support | link power save | to TRUE. |
| | support is | 1 - Supported |
| | implemented | 0- Indicates not supported |
| Length | This indicates the | This field is present if the feature is supported. |
| | length of the power | Else absent. |
| | save feature | |
| | capability | |
| | information | |
| Number of | This indicates how | |
| links | many links support | |
| | cross link power save | |
| | mechanism | |
| Primary | This filed indicates | 00 - Any link can be a primary link |
| Link# | whether a primary | XX - Link ID# of primary link |
| | link is identified for | |
| | cross link operations | |
| | or any link can be | |
| | used to update the | |
| | power management | |
| | modes of other links | |
| Supported | This field shall | XX - Link ID# if cross link power save is supported |
| Link ID# | indicate the link ID of | on this link |
| | the all the links that | |
| | shall support cross | |
| | link power save | |

As described herein, the method 300 discloses a capability framework for current standard design principles. The method 300 discloses details in capabilities, and provides the flexibility to a vendor on the type of power save features that can be implemented and the corresponding capability exchanged.

In an embodiment, the method 300 introduces the power save feature capabilities within UHR capabilities, and power save feature capabilities as a new Information Element (IE) within capability. The method 300 introduces frame format for power save capabilities, element, element ID details, dot11 features associated with the candidate power save features, and capabilities request/response framework and associated frame format.

The method 300 introduces the frame format for each power save feature considering implementation aspects specifically for multi-link devices. The method 300 introduces dynamic power save feature capability frame format for single and multi-link operations. The method 300 introduces scheduled power save feature capability frame format for single and multi-link operations. The method 300 introduces cross-link power save feature capability frame format.

In some examples, the device comprises at least one processor including processing circuitry and memory storing instructions. The instructions, when executed by the at least one processor individually or collectively, cause the device to send information on power save features to a receiving device, wherein the information is included in the UHR MAC capabilities field.

In some examples, the UHR MAC capabilities field includes a dynamic power save (PS) field for Dynamic Power Save (DPS).

In some examples, the UHR MAC capabilities field includes a scheduled power save field for scheduled Power Save (PS).

In some examples, the UHR MAC capabilities field includes a cross-link power save field for a cross-link PS.

In some examples, the device comprises at least one processor including processing circuitry and memory storing instructions. The instructions, when executed by the at least one processor individually or collectively, cause the device to determine whether to send one or more power save features to at least one receiving device. The instructions, when executed by the at least one processor individually or collectively, further cause the device to generate at least one information field in at least one frame associated with indicating the one or more power save features. The instructions, when executed by the at least one processor individually or collectively, further cause the device to transmit at least one generated information field in the frame to the receiving device.

In some examples, the device comprises at least one Access Point (AP), and the receiving device comprises at least one non-AP Station (non-AP STA). In some examples, the device comprises the at least one non-AP STA and the receiving device comprises the at least one AP.

In some examples, the instructions, when executed by the at least one processor individually or collectively, further cause the device to determine whether the one or more power save features are implemented in the device. The instructions, when executed by the at least one processor individually or collectively, further cause the device to determine to send at least one power save capability associated with the at least one power save feature of the one or more power save features implemented in the device to the receiving device.

In some examples, the at least one information field is related to one or more power save capabilities to support functioning of the one or more power save features in one or more frames. The one or more power save capabilities comprises at least one of a dynamic power save feature support, a scheduled power save feature support, a cross-link power save feature support, or an assistance support for a peer STA to enable the one or more power save features and the associated one or more power save capabilities. The one or more frames comprises at least one of a beacon, an association request, an association response, a (re)association request, a re(association) response, a probe request, or a probe response.

In some examples, the at least one information field is related to the one or more power save capabilities in the one or more frames through at least one Ultra High Reliability (UHR) capability information field. The one or more power save features and associated one or more power save capabilities are introduced in a UHR Media Access Control (MAC) capabilities field of the at least one UHR capability information field. The UHR MAC capabilities field includes support for each power save feature of the one or more power save features.

In some examples, the at least one information field is related to the one or more power save capabilities in the one or more frames through at least one power save capabilities information field. The one or more power save features and the associated one or more power save capabilities are in the at least one power save capabilities information field. The power save capabilities information field of at least one frame comprises an associated element ID and an element ID extension.

In some examples, the at least one power save capabilities information field comprises at least one of a support of a type of a power save feature, a frame format for each power save capability associated with the one or more power save features, at least one mode of the one of more power save features, a number of links supported, or a link ID for each supported link. The frame format further includes a power save feature ID, a length, and details for each power save feature of the one or more power save features.

In some examples, the type of the power save feature comprises at least one of a dynamic power save feature, a scheduled power save feature, or a cross-link power save feature. Each power save feature of the one or more power save features is enabled if a corresponding second feature support is implemented for indicating a supporting value for implementing the power save feature of the one or more power features.

In some examples, the at least one mode of the power save feature comprises at least one of a Bandwidth (BW), a Number of Spatial Stream (NSS), or a Modulation and Coding Scheme (MCS), wherein the at least one mode of the power save feature is applicable for one of a low capability mode and a high capability mode.

In some examples, the first device includes at least one processor including processing circuitry and memory storing instructions. The instructions, when executed by the at least one processor individually or collectively, cause the first device to transmit, to a second device, a request for one or more power save features implemented at the second device. The instructions, when executed by the at least one processor individually or collectively, further cause the first device to receive, from the second device, at least one information field in at least one frame associated with indicating the one or more power save features. The instructions, when executed by the at least one processor individually or collectively, further cause the first device to determine the one or more power save features implemented in the second device based on receiving the at least one information field.

In some examples, the device comprises at least one Access Point (AP), and the receiving device comprises at least one non-AP Station (non-AP STA). In some examples, the device comprises the at least one non-AP STA and the receiving device comprises the at least one AP.

In some examples, a method for facilitating communication in a wireless communication network is provided. The method comprises determining, by a transmitting device, whether to send one or more power save features to a receiving device. The method comprises generating, by the transmitting device, at least one information field in at least one frame associated with indicating the one or more power save features. The method comprises transmitting, by the transmitting device, the at least one generated information field in the at least one frame associated with indicating the one or more power save features to the receiving device.

In some examples, the transmitting device comprises at least one access point (AP) and the receiving device comprises at least one non-AP station (non-AP STA). In some examples, the transmitting device comprises the at least one non-AP STA and the receiving device comprises the at least one AP.

One aspect of the present disclosure provides a device that generates a frame including UHR MAC capabilities field. The UHR MAC capabilities field includes information on what kind of power save features are supported by the device.

One aspect of the present disclosure provides a first device comprises at least one processor including processing circuitry. The first device comprises memory storing instructions. The instructions, when executed by the at least one processor individually or collectively, cause the first device to generate a capability request message.

In some examples, the instructions, when executed by the at least one processor individually or collectively, cause the first device to transmit the capability request message to a second device. In some examples, the instructions, when executed by the at least one processor individually or collectively, cause the first device to receive the capability response message from the second device.

In some examples, the power request message includes a power save capability field. The power save capability field includes an information whether a power save feature is requested or not.

In some examples, the power save capability field is included in a UHR MAC capabilities field of the frame.

In some examples, the second device comprises at least one processor including processing circuitry. The second device comprises memory storing instructions. The instructions, when executed by the at least one processor individually or collectively, cause the second device to transmit a capability response message to the first device in response to the capability request message from the first device.

In some examples, the capability response message is included in a UHR MAC capabilities field of the frame.

In some examples, the capability response message includes a first length field, one or more power save feature fields. The first length field indicates the length of the one or more power save feature fields. For example, the first length field indicates the sum of the length of each power save feature field. Each of the one or more power save feature fields includes a second length field and a field for detailed information for a respective power save feature. The second length field indicates the length of the field for detailed information.

In some examples, the one or more power save feature fields have different formats according to power save feature associated with the one or more power save feature fields. For examples, a first power save feature field of the one or more power save feature fields is associated with dynamic power save feature and a second power save feature field of the one or more power save feature fields is associated with schedule power save feature, the format of the first power save feature field is different from the format of the second power save feature field.

In some examples, a first power save field of the one or more power save feature fields is associated with dynamic power save feature. The first power save field includes a third length field, a primary link ID field, a number of links field, a low capability mode field, and/or a high capability field. The third length field indicates the length of the first power save field. The primary link ID field indicates the preferred primary link ID that the ICF is exchanged during DPS mode on. The number of links field indicates how many links support a dynamic power save feature. The low capability mode field indicates a first link ID and low capability mode feature corresponding to the first link ID. The high capability mode field indicates a second link ID and high capability mode feature corresponding to the second link ID.

In some examples, a second power save field of the one or more power save feature fields is associated with scheduled power save feature in a single link. The second power save field includes a fourth length field, a doze mode support field and one or more reduced capability mode fields. The fourth length field indicates the length of the second power save field. The doze mode support field indicates one or more doze modes the device can support. The one or more reduced cap mode fields include a MCS field that indicates the maximum MCS that the device can support in a reduced capability mode. The one or more reduced cap mode fields include an NSS field that indicates the maximum spatial streams that the device can support in a reduced cap mode. The one or more reduced capability mode fields include a BW field that indicates the maximum bandwidth that the device can support in a low capability mode.

In some examples, a third power save field of the one or more power save feature fields is associated with scheduled power save feature in multiple links. The third power save field includes a fifth length field, a Number of Links field and a doze mode capability field. The fifth length field indicates the length of the third power save field. The Number of Links field indicates how many links support SPS over the multiple links. The doze mode capability field indicates a link ID and doze mode capabilities corresponding to the link ID.

In some examples, a fourth power save field of the one or more power save feature fields is associated with cross link power save feature. The fourth power save field includes a sixth length field, a Number of Links field, a primary link field, and a supported link ID field. The sixth length field indicates the length of the fourth power save field. The Number of Links field indicates how many links support cross link power save feature. The primary link field indicates whether a primary field is identified for cross link operations or whether any link can be used to update the power management modes of other links. The supported link ID field indicates the link ID of all the links that support cross link power save feature.

In some examples, the first device is an access point (AP), and the second device is a non-AP station. In some examples, the first device is a non-AP station, and the second device is an access point (AP).

One aspect of the present disclosure provides a non-transitory computer-readable storage medium. The above methods can be performed by one or more computer programs stored on the non-transitory computer-readable storage medium.

In some examples, the non-transitory computer-readable storage medium stores one or more computer programs, when executed by at least one processor individually or collectively, cause the device to determine whether to send one or more power save features to a receiving device. The one or more computer programs, when executed by at least one processor individually or collectively, further cause the device to generate at least one information field in at least one frame associated with indicating the one or more power save features. The one or more computer programs, when executed by at least one processor individually or collectively, further cause the device to transmit the at least one generated information field in the at least one frame to the receiving device.

The embodiments disclosed herein can be implemented through at least one software program running on at least one hardware device. The elements shown in FIG. 2 include blocks which can be at least one of a hardware device, or a combination of hardware device and software module.

The embodiment disclosed herein describes systems 200 and methods 300 for defining power save capabilities in Ultra High Reliability (UHR). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL), another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

A phrase “at least one of” preceding a series of times, with the terms “and” or “or” to separate any of the times, modifies the list as a whole, rather than each member of the list. The phrase “at least one of” does not require a selection of least one item, rather, the phrase allows a meaning that includes at least one of any one of the items, and/or at least one of any combination of the items, and/or at least one of each of the items. By way of example, each of the phrases “as least one of A, B, and C” or “at least of A, B, or C” refers to Only A, only B, only C, any combination of A, B, and C, and/or at least each of A, B, and C.

What is claimed is:

1. A device, comprising:
at least one processor including processing circuitry; and
memory storing instructions that, when executed by the at least one processor individually or collectively, cause the device to:
generate at least one frame to include at least one information field, the at least one information field indicating one or more power save features; and
transmit the at least one frame including the at least one generated information field to the receiving device.

2. The device of claim 1, wherein:
the device comprises at least one Access Point (AP) and the receiving device comprises at least one non-AP Station (non-AP STA); or
the device comprises the at least one non-AP STA and the receiving device comprises the at least one AP.

3. The device of claim 1, wherein the instructions, when executed by the at least one processor individually or collectively, further cause the device to:
determine whether the one or more power save features are implemented in the device; and
determine to send at least one power save capability associated with the at least one power save feature of the one or more power save features implemented in the device to the receiving device.

4. The device of claim 1, wherein the at least one information field is related to one or more power save capabilities to support functioning of the one or more power save features in one or more frames, wherein the one or more power save capabilities comprises at least one of a dynamic power save feature support, a scheduled power save feature support, a cross-link power save feature support, or an assistance support for a peer STA to enable the one or more power save features and the associated one or more power save capabilities, wherein the one or more frames comprises at least one of a beacon, an association request, an association response, a (re)association request, a re(association) response, a probe request, or a probe response.

5. The device of claim 4, wherein the at least one information field is related to the one or more power save capabilities in the one or more frames through at least one Ultra High Reliability (UHR) capability information field, wherein the one or more power save features and associated one or more power save capabilities are introduced in a UHR Media Access Control (MAC) capabilities field of the at least one UHR capability information field, wherein the UHR MAC capabilities field includes support for each power save feature of the one or more power save features.

6. The device of claim 4, wherein the at least one information field is related to the one or more power save capabilities in the one or more frames through at least one power save capabilities information field, wherein the one or more power save features and the associated one or more power save capabilities are in the at least one power save capabilities information field, wherein the power save capabilities information field of at least one frame comprises an associated element ID and an element ID extension.

7. The device of claim 6, wherein the at least one power save capabilities information field comprises at least one of a support of a type of a power save feature, a frame format for each power save capability associated with the one or more power save features, at least one mode of the one of more power save features, a number of links supported, or a link ID for each supported link, wherein the frame format further includes a power save feature ID, a length, and details for each power save feature of the one or more power save features.

8. The device of claim 7, wherein the type of the power save feature comprises at least one of a dynamic power save feature, a scheduled power save feature, or a cross-link power save feature, wherein each power save feature of the one or more power save features is enabled if a corresponding second feature support is implemented for indicating a supporting value for implementing the power save feature of the one or more power features.

9. The device of claim 7, wherein the at least one mode of the power save feature comprises at least one of a Bandwidth (BW), a Number of Spatial Stream (NSS), or a Modulation and Coding Scheme (MCS), wherein the at least one mode of the power save feature is applicable for one of a low capability mode and a high capability mode.

10. A first device, comprising:
at least one processor including processing circuitry; and
memory storing instructions that, when executed by the at least one processor individually or collectively, cause the device to:
transmit, to a second device, a request for one or more power save features that is supported the second device;
receive, from the second device, at least one frame including at least one information field, the at least one information field indicating the one or more power save features; and
determine the one or more power save features that is supported in the second device based on the at least one information field in the at least one frame.

11. The first device of claim 10, wherein:
the first device is an access point (AP), and the second device is a non-AP station (STA); or
the first device is the non-AP STA, and the second device is the AP.

12. A method for facilitating communication in a wireless communication network, comprising:
generating, by a transmitting device, at least one frame to include at least one information field, the at least one information frame indicating one or more power save features; and
transmitting, by the transmitting device, the at least one frame including the at least one information field to the receiving device.

13. The method of claim 12, wherein:
the transmitting device comprises at least one access point (AP) and the receiving device comprises at least one non-AP station (non-AP STA); or
the transmitting device comprises the at least one non-AP STA and the receiving device comprises the at least one AP.

14. The method of claim 12, wherein the determining whether to send the one or more power save features, comprises:
determining, by the transmitting device, whether the one or more power save features are implemented in the transmitting device; and
determining, by the transmitting device, to send at least one power save capability associated with the one or more power save features implemented in the transmitting device.

15. The method of claim 12, wherein the at least one information field is related to one or more power save capabilities to support functioning of the one or more power save features in one or more frames, wherein the one or more power save capabilities comprises at least one of a dynamic power save feature support, a scheduled power save feature support, a cross-link power save feature support, or an assistance support for a peer STA to enable the one or more power save features and associated one or more power save capabilities, wherein the one or more frames comprises at least one of a beacon, an association request, an association response, a (re)association request, a (re)association response field, a probe request, or a probe response.

16. The method of claim 15, wherein the at least one information field related is to the one or more power save capabilities in the one or more frames through at least one Ultra High Reliability (UHR) capability information field, wherein the one or more power save features and associated one or more power save capabilities are introduced in a UHR Media Access Control (MAC) capabilities field of the at least one UHR capability information field, wherein the UHR MAC capabilities field includes support for each power save feature of the one or more power save features.

17. The method of claim 15, wherein the at least one information field is related to the one or more power save capabilities in the one or more frames through at least one power save capabilities information field, wherein the one or more power save features and the associated one or more power save capabilities are in the at least one power save capabilities information field, wherein the power save capabilities information field of at least one frame comprises an associated element ID and an element ID extension.

18. The method of claim 17, wherein the at least one power save capabilities information field comprises at least one of a support of a type of a power save feature, a frame format for each power save capability associated with the one or more power save features, at least one mode of the one or more power save features, a number of links supported, or a link ID for each supported link, wherein the frame format further includes a power save feature ID, a length and, details for each power save feature of the one or more power save features.

19. The method of claim 18, wherein the type of the power save feature comprises at least one of a dynamic power save feature, a scheduled power save feature, or a cross-link power save feature, wherein each power save feature of the one or more power save features is enabled if a corresponding second feature support is implemented for indicating a supporting value for implementing the power save feature of the one or more power save features.

20. The method of claim 18, wherein the at least one mode of the power save feature comprises at least one of a Bandwidth (BW), a Number of Spatial Stream (NSS), or a Modulation and Coding Scheme (MCS), wherein the at least one mode of the power save feature is applicable for one of a low capability mode and a high capability mode.
